(19) United States
(12) Patent Application Publication
(10) Pub. No.: US 2025/0203289 A1
(43) Pub. Date: Jun. 19, 2025

(54) ELECTRONIC DEVICE FOR PROCESSING SOUND DIFFERENTLY ACCORDING TO MODE, AND CONTROL METHOD THEREOF

(71) Applicant: SAMSUNG ELECTRONICS CO., LTD., Suwon-si Gyeonggi-do (KR)

(72) Inventors: Jongwoo KIM, Suwon-si (KR); Haekwang PARK, Suwon-si (KR); Sunmin KIM, Suwon-si (KR); Hanki KIM, Suwon-si (KR)

(73) Assignee: SAMSUNG ELECTRONICS CO., LTD., Suwon-si Gyeonggi-do (KR)

(21) Appl. No.: 19/070,759

(22) Filed: Mar. 5, 2025

Related U.S. Application Data
(63) Continuation of application No. PCT/KR2023/015170, filed on Oct. 4, 2023.

(30) Foreign Application Priority Data
Nov. 30, 2022 (KR) 10-2022-0164882

(51) Int. Cl. H04R 3/12; G06F 3/16; G10L 21/0208; G10L 21/0364; H04R 5/02; H04S 3/00

(52) U.S. Cl. CPC H04R 3/12; G06F 3/165; G10L 21/0208; G10L 21/0364; H04R 5/02; H04S 3/008; H04S 2400/01; H04S 2400/13

(57) ABSTRACT

An electronic device including at least one speaker, a communication interface, and at least one processor that is connected with the at least one speaker and the communication interface and controls the electronic device. The processor, when the electronic device is in a first mode, may output one or more first channel signals included in a sound via at least one speaker and control the communication interface to transmit one or more second channel signals in the sound to at least one external speaker, and when the electronic device is in a second mode, mix at least one of the one or more first channel signals and the one or more second channel signals to thereby produce a mixed signal and control the communication interface to transmit the mixed signal to the at least one external speaker.

### CROSS-REFERENCE TO RELATED APPLICATIONS

This application is a continuation of International Application No. PCT/KR2023/015170, filed Oct. 4, 2023, and claims foreign priority to Korean Application No. 10-2022-0164882, filed Nov. 30, 2022, which are incorporated herein by reference in their entireties.

### TECHNICAL FIELD

The present disclosure relates to an electronic device and a control method thereof and more particularly, to an electronic device differently processing sound according to a mode and a control method thereof.

### BACKGROUND ART

Sound equipment may be classified in various classification methods. In particular, the sound equipment may be classified as a device used by a family together or concurrently and a device used by an individual based on a subject of usage. For example, the former is a sound bar and the latter is a Wi-Fi speaker, a Bluetooth speaker, etc. If there is the sound bar, it may be difficult to additionally prepare the sound equipment for the individual due to a problem such as a cost, a space, etc.

In general, there are many cases that the sound bar is installed together with a TV proving a screen to a space shared by the family such as a living room, and thus a product supporting a multi-channel output is a majority. The multi-channel output may provide a relatively wide sweet spot and many people may enjoy sound at the same time. In particular, a recent multi-channel sound bar supports a wireless rear speaker capable of being wirelessly connected to a main body for convenient installation. In contrast, there are many cases that the Wi-Fi speaker, or the like supports only a mono or stereo output by which movement of the speaker is free and installation is convenient.

It may be difficult to use the multi-channel sound bar as individual sound equipment due to its comparatively large size and restriction of movement. On the contrary, it is difficult for the Wi-Fi speaker, or the like to provide a wide sound image due to its small size and a fewer number of output channels and thus, it may be deficient to be enjoyed by many people like the sound bar.

A partial Wi-Fi speaker, or the like may be in connection with a plurality of Wi-Fi speakers, or the like to be used as sound equipment for the family. For example, two Bluetooth speakers supporting a connection function may be connected to be used as a stereo speaker of a TV or four Wi-Fi speakers may be connected to be used as four channel speakers of the TV. In this case, signal synchronization between each of speakers, synchronization between the screen and sound of the TV (lip sync), and prevention of sound disconnection are important. For synchronization, responsiveness between an input and an output of a sound system is an important element. However, if the responsiveness is fast, synchronization between speakers is difficult or sound disconnection resulting from a wireless communication environment may occur, and if the responsiveness is slow, sound more slowly comes out than the screen and there may be a problem in synchronization with the screen.

Accordingly, there are limitations in using the individual sound equipment as sound equipment for the family.

### DISCLOSURE

### Technical Solution

According to an embodiment of the disclosure for achieving an aspect as above, an electronic device may include at least one speaker, a communication interface, and at least one processor. The at least one processor may be configured to, based on the electronic device being in a first mode, output a signal of at least one first channel included in sound through the at least one speaker and control the communication interface to transmit a signal of at least one second channel included in the sound to at least one external speaker, and based on the electronic device being in a second mode, mix at least one of signals of the at least one first channel and a signal of the at least one second channel to thereby produce a mixed signal and control the communication interface to transmit the mixed signal to the at least one external speaker.

Also, the at least one processor may apply at least one of a dynamic range control (DRC) or a filter to the mixed signal.

Further, the at least one processor may apply a first DRC to increase an amplitude of a user voice in the mixed signal and apply a second DRC to decrease an amplitude of background sound in the mixed signal, and apply the filter which enhances clarity of a voice to the user voice.

Also, the electronic device may further include an amplifier (amp) which amplifies and provides the signal of the at least one first channel to the at least one speaker, wherein the at least one processor may include a mixer configured to perform the mixing, and a sound processing module configured to apply the DRC or the filter, wherein the at least one processor, based on the electronic device being in the first mode, may turn off the sound processing module, and based on the electronic device being in the second mode, may turn off the amp.

Further, the at least one processor may change a mode of the electronic device to one of the first mode or the second mode based on a volume of the electronic device.

Also, the at least one processor may apply a first gain to at least one of the signals of the at least one first channel, apply a second gain to the signal of the at least one second channel, and mix the at least one of the signals of the at least one first channel to which the first gain is applied and the signal of the at least one second channel to which the second gain is applied.

Further, the signal of the at least one first channel may include a front left signal, a front right signal, a center signal, and a sub-woofer signal, wherein the signal of the at least one second channel may include a rear left signal and a rear right signal, and wherein the at least one processor, based on the electronic device being in the first mode, may output the front left signal, the front right signal, and the center signal through the at least one speaker and control the communication interface to transmit the rear left signal, the rear right signal, and the sub-woofer signal to the at least one external speaker, and based on the electronic device being in the second mode, may mix the front left signal, the center signal, and the rear left signal, mix the front right signal, the center signal, and the rear right signal, and control the communication interface to transmit the mixed signals to the at least one external speaker.

Also, the at least one external speaker may include a rear left speaker, a rear right speaker, and a woofer speaker, and wherein the at least one processor, based on the electronic device being in the first mode, may control the communication interface to transmit the rear left signal to the rear left speaker, transmit the rear right signal to the rear right speaker, and transmit the sub-woofer signal to the woofer speaker, and based on the electronic device being in the second mode, may mix and control the communication interface to transmit the front left signal, the center signal, and the rear left signal to the rear left speaker, mix and control the communication interface to transmit the front right signal, the center signal, and the rear right signal to the rear right speaker.

Further, the at least one processor, based on the rear left speaker and the rear right speaker being not identified, may mix the front left signal and the rear left signal, mix the front right signal and the rear right signal and output the mixed signals through the at least one speaker.

Also, the electronic device may further include a sensor, wherein the at least one processor may identify at least one of a number of a user or a position of the user around the electronic device through the sensor, and change a mode of the electronic device to one of the first mode or the second mode based on the identified at least one of a number of a user or a position of the user.

Meanwhile, according to an embodiment of the disclosure, a method of controlling an electronic device includes, based on the electronic device being in a first mode, outputting a signal of at least one first channel included in sound through at least one speaker included in the electronic device and transmitting a signal of at least one second channel included in the sound to at least one external speaker, and based on the electronic device being in a second mode, mixing at least one of signals of the at least one first channel and a signal of the at least one second channel to thereby produce a mixed signal and transmitting the mixed signal to the at least one external speaker.

Also, the method may further include applying at least one of a DRC or a filter to the mixed signal.

Further, the applying the at least one may include applying a first DRC to increase an amplitude of a user voice in the mixed signal and applying a second DRC to decrease an amplitude of background sound in the mixed signal, and applying the filter which enhances clarity of a voice to the user voice.

Also, the applying the at least one may include applying the DRC or the filter through a sound processing module, wherein the transmitting the signal of the at least one second channel to the at least one external speaker includes amplifying the signal of the at least one first channel by using an amp to provide an amplified signal to the at least one speaker and turning off the sound processing module, and wherein the transmitting the mixed signal to the at least one external speaker may include turning off the amp.

Further, the method may further include changing a mode of the electronic device to one of the first mode or the second mode based on a volume of the electronic device.

Also, the transmitting the mixed signal to the at least one external speaker may include applying a first gain to at least one of the signals of the at least one first channel, applying a second gain to the signal of the at least one second channel, and mixing the at least one signal to which the first gain is applied and the signal of the at least one second channel to which the second gain is applied.

Further, the signal of the at least one first channel may include a front left signal, a front right signal, a center signal, and a sub-woofer signal, wherein the signal of the at least one second channel may include a rear left signal and a rear right signal, and wherein the transmitting the signal of the at least one second channel to the at least one external speaker may include, based on the electronic device being in the first mode, outputting the front left signal, the front right signal, and the center signal through the at least one speaker and transmitting the rear left signal, the rear right signal, and the sub-woofer signal to the at least one external speaker, and the transmitting the mixed signal to the at least one external speaker may include, based on the electronic device being in the second mode, mixing the front left signal, the center signal, and the rear left signal, mixing the front right signal, the center signal, and the rear right signal, and transmitting the mixed signals to the at least one external speaker.

Also, the at least one external speaker may include a rear left speaker, a rear right speaker, and a woofer speaker, wherein the transmitting the signal of at least one second channel to the at least one external speaker may include, based on the electronic device being in the first mode, transmitting the rear left signal to the rear left speaker, transmitting the rear right signal to the rear right speaker, and transmitting the sub-woofer signal to the woofer speaker, and the transmitting the mixed signal to the at least one external speaker may include, based on the electronic device being in the second mode, mixing and transmitting the front left signal, the center signal, and the rear left signal to the rear left speaker, and mixing and transmitting the front right signal, the center signal, and the rear right signal to the rear right speaker.

Further, the method may further include, based on the rear left speaker and the rear right speaker being not identified, mixing the front left signal and the rear left signal, mixing the front right signal and the rear right signal and outputting the mixed signals through the at least one speaker.

Also, the method may further include identifying at least one of a number of a user or a position of the user around the electronic device, and changing the mode of the electronic device to one of the first mode or the second mode based on the identified information.

### DESCRIPTION OF DRAWINGS

FIGS. 1A to 1C are views briefly illustrating a method of utilizing sound equipment for a family for helping understanding the disclosure;

FIG. 2 is a block diagram illustrating a configuration of an electronic system according to an embodiment;

FIG. 3 is a block diagram illustrating a configuration of an electronic device according to an embodiment;

FIG. 4 is a block diagram illustrating a detailed configuration of an electronic device according to an embodiment;

FIG. 5 is a view illustrating a circuitry configuration for operation according to a mode of an electronic device 100 according to an embodiment;

FIG. 6 is a view illustrating operation of a first mode of an electronic device 100 according to an embodiment;

FIG. 7 is a view illustrating operation of a second mode of an electronic device 100 according to an embodiment;

FIG. 8 is a view illustrating a sound processing module according to an embodiment; and

FIG. 9 is a flow chart illustrating a method of controlling an electronic device according to an embodiment.

### MODE FOR INVENTION

An aspect of the disclosure is to provide an electronic device differently processing sound according to a mode in order to use sound equipment for a family as individual sound equipment and a control method thereof.

The disclosure is specifically described with reference to the appended drawings hereinafter.

The terms used in embodiments of the disclosure are selected as general terms which are currently widely used as much as possible in consideration of functions in the disclosure but may be varied depending on intention of those skilled in the art, a precedent, appearance of new technologies, or the like. Also, there is a term which is arbitrarily selected by the applicant in a certain case and in this case, its meaning is specifically described in the relevant description part of the disclosure. Therefore, the term used in the disclosure should be defined based on the meaning of the term and the entire content throughout the disclosure rather than the simple name of the term.

In the specification, the expression “have,” “may have,” “include” or “may include” denotes the existence of such characteristic (e.g. a numerical value, a function, an operation, or a component such as a part) and does not exclude the existence of additional characteristics.

The expression “at least one of A and/or B” should be interpreted to mean any one of “A” or “B” or “A and B”.

The expression “1st”, “2nd”, “first”, “second”, or the like used in the specification may be used to describe various elements regardless of any order and/or degree of importance, wherein such expression is used only to distinguish one element from another element and is not intended to limit the relevant element.

A singular expression includes a plural expression, unless obviously differently defined in the context. In the application, the term such as “include” or “consist of” should be construed as designating that there are such characteristics, numbers, steps, operations, components, parts, or a combination thereof described in the specification but not as excluding in advance possibility of the existence or addition of one or more other characteristics, numbers, steps, operations, components, parts, or a combination thereof.

In the disclosure, the term “user” may be referred to as a person who uses an electronic device or a device which uses the electronic device (e.g. an artificial intelligence (AI) electronic device).

Hereinafter, various embodiments of the disclosure are more specifically described with reference to the appended drawings.

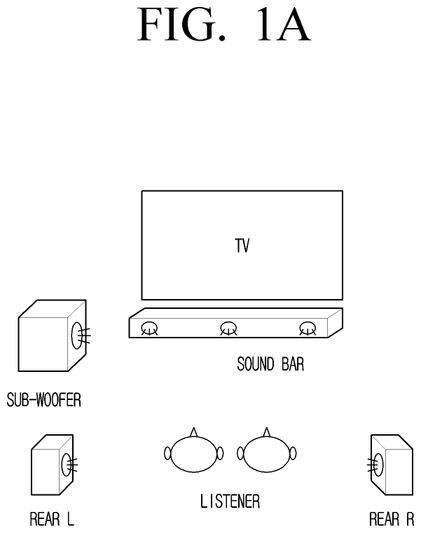

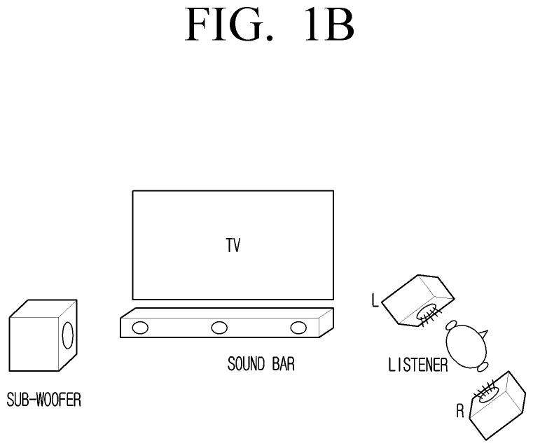

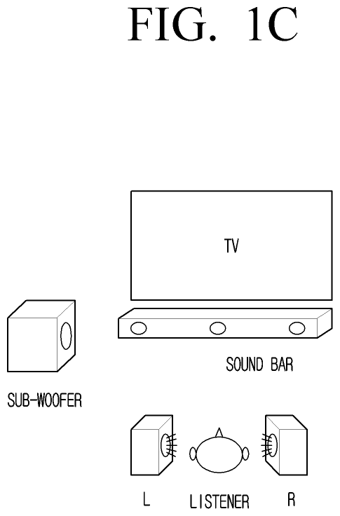

FIGS. 1A to 1C are views briefly illustrating a method of utilizing sound equipment for a family for helping understanding the disclosure.

If the sound bar may be used like individual sound equipment, it may be usually used by the family together, and when required, it may be used as individual sound equipment at a position desired by the individual.

For example, the sound bar may be used by the family together as shown in FIG. 1A. In this case, the sound bar may directly output a signal of a partial channel, transmit a signal of the other channel to a sub-woofer speaker, a rear L speaker, and a rear R speaker, and output a signal of a channel received by each of the sub-woofer speaker, the rear L speaker, and the rear R speaker.

Here, the user may use the rear L speaker and the rear R speaker as individual sound equipment as shown in FIGS. 1B and 1C. In this case, a proper volume is provided to a user who is closely positioned and a small volume is provided to a user who is remotely positioned, and thus even if the sound bar is used, possibility in that sound of a TV content interrupts other persons may be lowered.

In particular, when it is used as individual sound equipment, if loud sound may be controlled not to be excessively loud and quiet sound may be controlled not to be excessively quiet by using a DRC, a volume may be always maintained in a certain range to maintain a low volume. Also, if clarity of a voice is enhanced to increase transmission in the same volume, the volume may be more lowered to reduce interrupting other users.

A case of using the sound bar is free from issues about synchronization with a screen, synchronization between speakers, or sound disconnection compared to a case of configuring sound equipment for the family by connecting Wi-Fi speakers. This is because differently from a multi-channel system which should be configured by a user, the sound bar is released in a state that all the above issues are verified at a time of release.

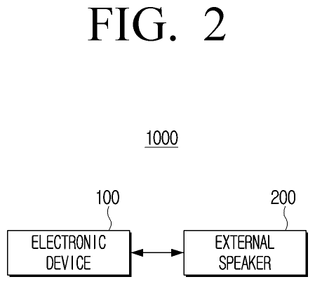

FIG. 2 is a block diagram illustrating a configuration of an electric system 1000 according to an embodiment. As shown in FIG. 2, the display system 1000 includes an electronic device 100 and an external speaker 200.

The electronic device 100 is a device processing sound and may be implemented as a sound bar, a TV, a desktop PC, a laptop, a smart phone, a tablet PC, smart glasses, a smart watch, etc. Meanwhile, the disclosure is not limited thereto and the electronic device 100 may be any device which may process sound.

The electronic device 100 may transmit at least one channel included in sound to the external speaker 200. Otherwise, the electronic device 100 may mix a partial channel included in sound and transmit the mixed signal to the external speaker 200.

The external speaker 200 may be a device which may receive a sound signal from the electronic device 100 and output the received sound signal. For example, the external speaker 200 may be a device which may receive a sound signal from the electronic device 100 through wireless communication and output the received sound signal. Here, the wireless communication be a unique communication standard of the electronic device 100 and the external speaker 200. Accordingly, it may be in a state that all issues such as synchronization with a screen, synchronization between speakers, or sound disconnection are verified.

The external speaker 200 may be implemented in plural numbers. For example, the external speaker 200 may include a rear left speaker, a rear right speaker, and a woofer speaker. Meanwhile, the disclosure is not limited thereto and an implementation method of the external speaker 200 may be various in any degree.

The external speaker 200 may be movable. For example, the external speaker 200 may be implemented to be relatively compact compared to the electronic device 100 and its position movement may be freer than that of the electronic device 100.

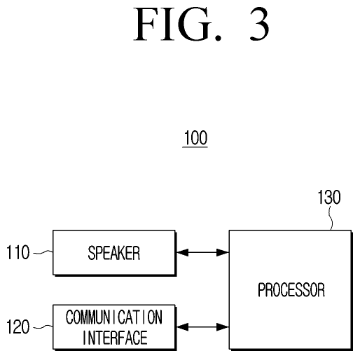

FIG. 3 is a block diagram illustrating a configuration of an electronic device 100 according to an embodiment.

According to FIG. 2, the electronic device 100 includes a speaker 110, a communication interface 120, and a processor 130.

The speaker 110 is a component outputting not only various audio data processed in the processor 130 but also various alarm sound, voice messages, or the like. For example, the processor 130 may output a signal of a partial channel included in sound through the speaker 110.

The speaker 110 may be implemented in plural numbers. For example, the speaker 110 may include a front left speaker, a front right speaker, and a center speaker. Meanwhile, the disclosure is not limited thereto and an implementation method of the speaker 110 may be various in any degree.

The communication interface 120 is a configuration performing communication with various types of external devices according to various types of communication methods. For example, the electronic device 100 may perform communication with the external speaker 200 through the communication interface 120.

The communication interface 120 may include a dedicated communication standard for communication with the external speaker 200. For example, in this case, communication between the electronic device 100 and the external speaker 200 may be possible without a separate connection operation, and interference of another communication signal may be also less.

Meanwhile, the disclosure is not limited thereto, and the communication interface 120 may include a Wi-Fi module, a Bluetooth module, an infrared communication module, a wireless communication module, etc. Here, each communication module may be implemented in a form of at least one hardware chip.

The Wi-Fi module and the Bluetooth module perform communication in a Wi-Fi method and a Bluetooth method, respectively. In case of using the Wi-Fi module or the Bluetooth module, the module may receive and transmit various connection information such as a SSID and a session key in advance, connect communication by using the connection information, and then receive and transmit various information. The infrared communication module may perform communication based on an infrared data association (IrDA) technology which transmits data wirelessly in a short distance by using infrared light between visible light and a millimeter wave.

The wireless communication module may include at least one communication chip performing communication according to various wireless communication standards such as Zigbee, a 3rd generation (3G), a 3rd generation partnership project (3GPP), long term evolution (LTE), LTE Advanced (LTE-A), a 4th generation (4G), and a 5th generation (5G) besides the aforementioned communication methods.

Otherwise, the communication interface 120 may include a wired communication interface such as a HDMI, DP, Thunderbolt, a USB, RGB, a D-SUB, a DVI, or the like.

Besides, the communication interface 120 may include at least one of a local area network (LAN) module, an Ethernet module, or a wired communication module performing communication by using a pair cable, a coaxial cable, a fiber optic cable, or the like.

The processor 130 controls operations of the electronic device 100 overall. Specifically, the processor 130 may be connected to each component of the electronic device 100 to control operations of the electronic device 100 overall. For example, the processor 130 may be connected to a component such as a speaker 110, a communication interface 120, an amp (not shown), a sensor (not shown), or the like to control operations of the electronic device 100.

At least one processor 130 may include one or more of a CPU, a Graphics Processing Unit (GPU), an Accelerated Processing Unit (APU), a Many Integrated Core (MIC), a Neural Processing Unit (NPU), a hardware accelerator, or a machine learning accelerator. The at least one processor 130 may control one or any combination of other components of the electronic device 100 and perform an operation related to communication or data processing. The at least one processor 130 may perform one or more programs or instructions stored in the memory. For example, the at least one processor 130 may perform a method according to an embodiment of the disclosure by executing one or more instructions stored in the memory.

If a method according to an embodiment of the disclosure includes a plurality of operations, the plurality of operations may be performed by one processor and may be performed by a plurality of processors. For example, when a first operation, a second operation, and a third operation are performed by a method according to an embodiment, all of the first operation, the second operation, and the third operation may be performed by a first processor and also, the first operation and the second operation are performed by the first processor (e.g. a general purpose processor) and the third operation may be performed by a second processor (e.g. an AI-dedicated processor).

The at least one processor 130 may be implemented as a single core processor including one core and may be implemented as one or more multi core processors including a plurality of cores (e.g. homogeneous multicores or heterogeneous multicores). If the at least one processor 130 is implemented as a multi core processor, each of the plurality of cores included in the multi core processor may include processor internal memory such as cache memory and on-chip memory, wherein a common cache shared by the plurality of cores may be included in the multi core processor. Also, each of the plurality of cores included in the multi core processor (or part of the plurality of cores) may read and perform program instructions for independently implementing a method according to an embodiment of the disclosure and also, may read and perform program instructions for implementing a method according to an embodiment of the disclosure in connection with all (or part) of the plurality of cores.

If a method according to an embodiment of the disclosure includes a plurality of operations, the plurality of operations may be performed by one core among the plurality of cores included in the multi core processor and may be performed by the plurality of cores. For example, when a first operation, a second operation, and a third operation are performed by a method according to an embodiment, all of the first operation, the second operation, and the third operation may be performed by a first core included in the multi core processor and also, the first operation and the second operation may be performed by the first core included in the multi core processor and the third operation may be performed by the second core included in the multi core processor.

In embodiments of the disclosure, at least one processor 130 may mean a System on Chip (SoC) onto which one or more processors and other electronic components are integrated, a single core processor, a multi core processor, or a core included in the single core processor or the multi core processor, wherein the core may be implemented as a CPU, a GPU, an APU, a MIC, a NPU, a hardware accelerator, or a machine learning accelerator, but embodiments of the disclosure are not limited thereto. Meanwhile, hereinafter, for convenience of the description, operations of the electronic device 100 are described based on the expression “processor 130”.

The processor 130 may identify a mode of the electronic device 100. For example, the processor 130 may change a mode of the electronic device 100 to one of a first mode or a second mode based on a volume of the electronic device 100. Here, the first mode may be a mode for family use and be in a case that family members use the electronic device 100, and the second mode may be a mode for individual use and be in a case that an individual among the family members uses the electronic device 100.

Meanwhile, the disclosure is not limed thereto, and the electronic device 100 may further include a sensor, and the processor 130 may identify the number of users or a position of the users around the electronic device 100 through the sensor and may change a mode of the electronic device 100 to one of the first mode or the second mode based on the identified information. For example, the processor 130 may determine a mode of the electronic device 100 based on the number of users within a preset distance from the electronic device 100. Here, the electronic device 100 may further include a camera, and the processor 130 may photograph the front of the electronic device 100 through the camera and identify at least one of the number of users or a position of the users from the photographed image.

The processor 130, if the electronic device 100 is in a first mode, may control the communication interface 120 to output a signal of at least one first channel included in sound through the at least one speaker 110 and transmit a signal of at least one second channel included in the sound to at least one external speaker 200, and if the electronic device is in a second mode, may control the communication interface 120 to mix at least one of signals of the at least one first channel to a signal of the at least one second channel and transmit the mixed signal to the at least one external speaker 200. That is, if the electronic device 100 is in the second mode, sound is not outputted through the at least one speaker 110 and sound is outputted only through at least one external speaker 200 and thus, damages of surrounding people due to the sound output may be minimized.

For example, a signal of the at least one first channel may include a front left signal, a front right signal, a center signal, and a sub-woofer signal, and a signal of the at least one second channel may include a rear left signal and a rear right signal. In this case, the processor 130, if the electronic device 100 is in a first mode, may control the communication interface 120 to output the front left signal, the front right signal, and the center signal through the at least one speaker 110 and transmit the rear left signal, the rear right signal, and the sub-woofer signal to the at least one external speaker 200, and if the electronic device 100 is in a second mode, may control the communication interface 120 to mix the front left signal, the center signal, and the rear left signal, mix the front right signal, the center signal, and the rear right signal, and transmit the mixed signals to the at least one external speaker 200.

Here, the at least one external speaker 200 may include a rear left speaker, a rear right speaker, and a woofer speaker, and the processor 130, if the electronic device 100 is in the first mode, may control the communication interface 120 to transmit the rear left signal to the rear left speaker, transmit the rear right signal to the rear right speaker, and transmit the sub-woofer signal to the woofer speaker, and if the electronic device 100 is in the second mode, may control the communication interface 120 to mix and transmit the front left signal, the center signal, and the rear left signal to the rear left speaker, mix and transmit the front right signal, the center signal, and the rear right signal to the rear right speaker.

The processor 130, if the rear left speaker and the rear right speaker is not identified, may mix the front left signal and the rear left signal, mix the front right signal and the rear right signal and output the mixed signals through at least one speaker 110.

As above, the description is made such that the mixing is performed between left signals and the mixing is performed between right signals, but the disclosure is not limited thereto. For example, the processor 130 may mix a left signal and a right signal to provide an effect.

Meanwhile, the at least one speaker 110 may include a front left speaker, a front right speaker, and a center speaker. In this case, the processor 130, if the electronic device 100 is in a first mode, may output a front left signal through the front left speaker, output a front right signal through the front right speaker, and output a center signal through the center speaker.

As above, the description is made such that the processor 130 mixes two signals one-to-one, but the disclosure is not limited thereto. For example, the processor 130 may apply a first gain to at least one of the signals of the at least one first channel, apply a second gain to the signal of the at least one second channel, and mix the at least one signal to which the first gain is applied and the signal of the at least one second channel to which the second gain is applied.

Also, the number of a channel included in sound, a type, and a configuration of the at least one speaker 110 and the at least one external speaker 200 may be variously modified in any degree.

The processor 130 may apply at least one of a DRC or a filter to the mixed signal. For example, the processor 130 may apply a first DRC to increase an amplitude of a user voice in the mixed signal and apply a second DRC to decrease an amplitude of background sound in the mixed signal, and apply the filter which enhances clarity of a voice to the user voice. In this case, the processor 130 may identify a user voice and background sound in the mixed signal.

Meanwhile, the disclosure is not limited thereto, and the processor 130 may not identify the user voice and the background sound in the mixed signal and apply the DRC to the mixed signal itself. For example, the processor 130 may apply the DRC in a method of, if a magnitude of the mixed signal is less than a preset magnitude, increasing the magnitude and if a magnitude of the mixed signal is equal to or greater than a preset magnitude, decreasing the magnitude.

Through this method, the user may minimize damages of surrounding people due to the sound output while more clearly identifying the user voice in sound.

Meanwhile, the electronic device 100 may further include an amp which amplifies and provides the signal of the at least one first channel to the at least one speaker, wherein the processor 130 may include a mixer performing mixing, and a sound processing module applying a DRC or a filter, wherein the processor, if the electronic device 100 is in the first mode, may turn off the sound processing module, and if the electronic device 100 is in the second mode, may turn off the amp.

Through this operation, electric power consumed in the sound processing module, the amp, or the like may be reduced.

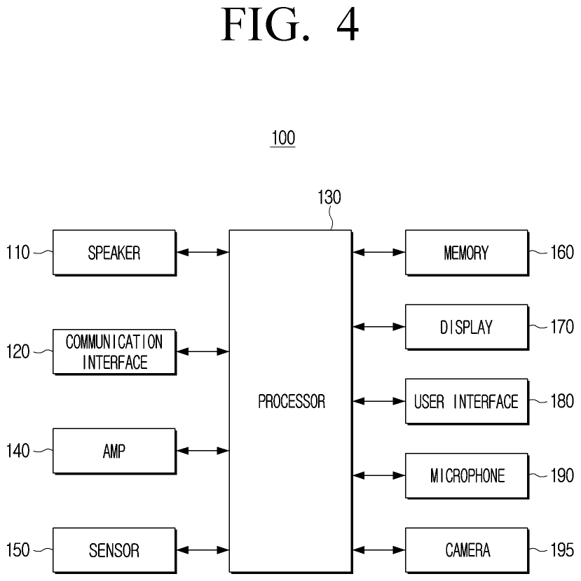

FIG. 4 is a block diagram illustrating a detailed configuration of an electronic device 100 according to an embodiment. The electronic device 100 may include a speaker 110, a communication interface 120, and a processor 130. Also, according to FIG. 4, the electronic device 100 may further include an amp 140, a sensor 150, memory 160, a display 170, a user interface 180, a microphone 190, and a camera 195. The detailed description of part overlapped with the components shown in FIG. 3 among the components shown in FIG. 4 is omitted.

The amp 140 may be a component which receives a sound signal, amplifies the sound signal, and provides the amplified sound signal to a speaker. For example, the amp 140 may amplify a signal of the at least one first channel and provide the amplified signal to the at least one speaker 110.

The sensor 150 may identify a user who is positioned at the front of the electronic device 100. For example, the sensor 150 may include a motion sensor, an infrared sensor, or the like and identify a user through the motion sensor, the infrared sensor, or the like.

If the sensor 150 includes a plurality of infrared sensors, the plurality of infrared sensors may be arranged in a line on the electronic device 100 and may identify an approximate position of the user positioned around the electronic device 100 according to existence or non-existence of a reflective wave.

Otherwise, the sensor 150 may include an ultrasonic sensor, a depth map, or the like and may be any component which may identify existence of the user.

Meanwhile, the disclosure is not limited thereto, wherein the processor 130 may identify at least one of the number of users or a position of the users through at least one of the microphone 190 or the camera 195 to be after-mentioned instead of the sensor 150.

The memory 160 may refer to hardware storing information such as data in an electric form or a magnetic form to be accessed by the processor 130 or the like. For the above, the memory 160 may be implemented as at least one hardware of non-volatile memory, volatile memory, flash memory, a hard disk drive (HDD) or a solid state drive (SDD), RAM, or ROM.

The memory 160 may store at least one instruction required for an operation of the electronic device 100 or the processor 130. Here, the instruction may be written in a machine language, which is a computer-understandable language as a code unit instructing an operation of the electronic device 100 or the processor 130. Otherwise, the memory 160 may store a plurality of instructions performing specific work of the electronic device 100 or the processor 130 as an instruction set.

The memory 160 may store data which is information in a bit or bite unit indicating a character, a number, an image, or the like. For example, the memory 160 may store mode information and mixing information.

The memory 160 may be accessed by the processor 130, wherein the processor 130 may perform reading/recording/correcting/deleting/renewing, or the like on the instructions, the instruction set, or data.

The display 170 is a component displaying an image and may be implemented as displays having various forms such as a liquid crystal display (LCD), an organic light emitting diode (OLED) display, and a plasma display panel (PDP). The display 170 may include a driving circuit which may be implemented in a form such as an a-si TFT, a low temperature poly silicon (LTPS) TFT, or an organic TFT (OTFT), a backlight unit, or the like therein. Meanwhile, the display 170 may be implemented as a touch screen coupled to a touch sensor, a flexible display, a 3D display, or the like.

The user interface 180 may be implemented as a button, a touch pad, a mouse, a keyboard, or the like or may be also implemented as a touch screen which may perform the display function and the manipulation input function together. Here, the button may be various types of buttons such as a mechanical button, a touch pad, or a wheel formed at any area such as a front part, a side part, a rear part, or the like of an appearance of a body of the electronic device 100.

The microphone 190 is a configuration for receiving sound and converting the sound to an audio signal. The microphone 190 may be electrically connected to the processor 130 and receive sound under control of the processor 130.

For example, the microphone 190 may be formed in an integral type as being integrated into an upper side of the electronic device 100 or in a front direction, a side direction, or the like. Otherwise, the microphone 190 may be included in a remote controller separate from the electronic device 100. In this case, the remote controller may receive sound through the microphone 190 and may provide the received sound to the electronic device 100.

The microphone 190 may include various components such as a microphone collecting sound in an analog form, an amp circuit amplifying the collected sound, an A/D conversion circuit sampling and converting the amplified sound to a digital signal, and a filter circuit removing a noise component from the converted digital signal.

Meanwhile, the microphone 190 may be implemented in a form of a sound sensor, wherein any type of configuration is proper if the configuration may collect sound.

The camera 195 is a component for capturing a static image or a moving image. The camera 195 may photograph a static image at a specific time point but may successively capture the static image.

The camera 195 may photograph the front of the electronic device 100 to photograph a real environment of the front of the electronic device 100. The processor 130 may identify a user based on the image photographed by the camera 195.

The camera 195 includes a lens, a shutter, an aperture, a solid-state imaging element, an analog front end (AFE), and a timing generator (TG). The shutter controls a time when light reflected from a subject enters into the camera 195, and the aperture controls an amount of light incident on the lens by mechanically increasing or reducing a size of an opening through which light enters. The solid-state imaging element, if light reflected from the subject is accumulated as a photo charge, outputs a pattern resulting from the photo charge as an electric signal. The TG outputs a timing signal for performing readout on pixel data of the solid-state imaging element, and the AFE samples and digitalizes the electric signal outputted from the solid-state imaging element.

As above, the electronic device 100 may provide a plurality of modes and minimize damages of surrounding people due to the sound output even in the case of the mode for individual use. In particular, in the case of the mode for individual use, the electronic device 100 may apply a DRC or a filter which enhances clarity of a voice to the mixed sound to improve user convenience.

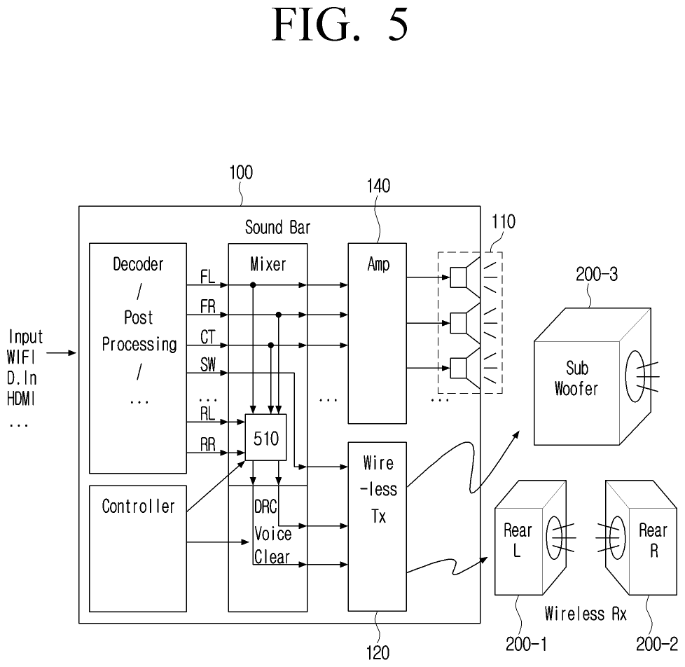

Hereinafter, operations of the display device 100 are more specifically described with reference to FIGS. 5 to 8. In FIGS. 5 to 8, individual examples are described for convenience of the description. Meanwhile, the individual examples of FIGS. 5 to 8 may be implemented in any combined state.

FIG. 5 is a view illustrating a circuitry configuration for operation according to a mode of an electronic device 100 according to an embodiment.

As shown in FIG. 5, the electronic device 100 may include a decoder/preprocessing module, a mixer, an amp 140, a controller, a sound processing module (DRC, voice clear), a speaker 110, and a communication interface 120. Here, the decoder/preprocessing module, mixer, sound processing module, and controller may be implemented as a configuration of the processor 130. In FIG. 5, for convenience of the description, the description is made such that the decoder/preprocessing module, mixer, sound processing module, and controller are individually implemented.

The decoder/preprocessing module may perform decoding, preprocessing, bass management, or the like on a signal received from the external device and provide sound including a plurality of channels to the mixer. For example, the decoder/preprocessing module may perform decoding, preprocessing, bass management, or the like on the signal received from the external device and provide a front left signal (FL), a front right signal (FR), a center signal (CT), a sub-woofer signal (SW), a rear left signal (RL), and a rear right signal (RR) to the mixer.

The mixer may process a signal of a plurality of channels received from the decoder/preprocessing module based on control of the controller. For example, the mixer, if the electronic device 100 is in the first mode, may provide the front left signal, the front right signal, and the center signal to the amp 140, provide the rear left signal and the rear right signal to the sound processing module, and transmit the sub-woofer signal to the woofer speaker 200-3 through the communication interface 120. Here, the amp 140 may amplify and provide the front left signal, the front right signal, and the center signal to the speaker 110, and the speaker 110 may output the amplified front left signal, front right signal, and center signal. The sound processing module may sound process the rear left signal and the rear right signal and may transmit the sound processed rear left signal and rear right signal to the rear left speaker 200-1 and the rear right speaker 200-2 through the communication interface 120, respectively.

Based on control of the controller, the mixer, if the electronic device 100 is in a second mode, mixes the front left signal, the center signal, and the rear left signal, mixes the front right signal, the center signal, and the rear right signal, and transmits the mixed signals to the rear left speaker 200-1 and the rear right speaker 200-2 through the communication interface 120.

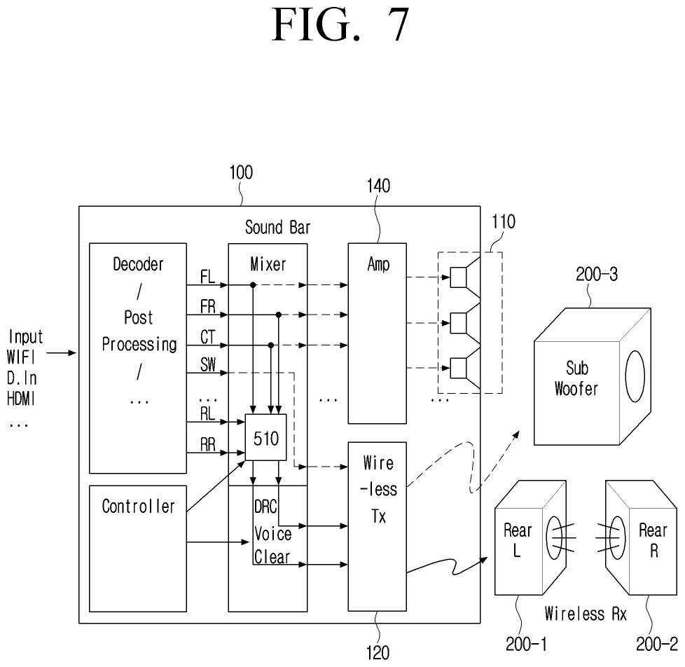

Here, the mixer may perform a mixing operation through a block 510. The mixing operation is more specifically described in FIG. 7.

The sound processing module may apply at least one of a DRC or a filter which enhances clarity of a voice in the mixed signal based on control of a controller.

The controller may control each component. In particular, the controller may identify a mode of the electronic device 100 and control each component based on the identified mode. Here, the mode may be determined according to a user command. Meanwhile, the disclosure is not limited thereto and the controller may change a mode of the electronic device 100 based on the volume of the electronic device 100. Otherwise, the controller may change a mode of the electronic device 100 based on at least one of the number or a position of users identified at the front of the electronic device 100.

A specific operation in each mode is described in the drawings hereinafter.

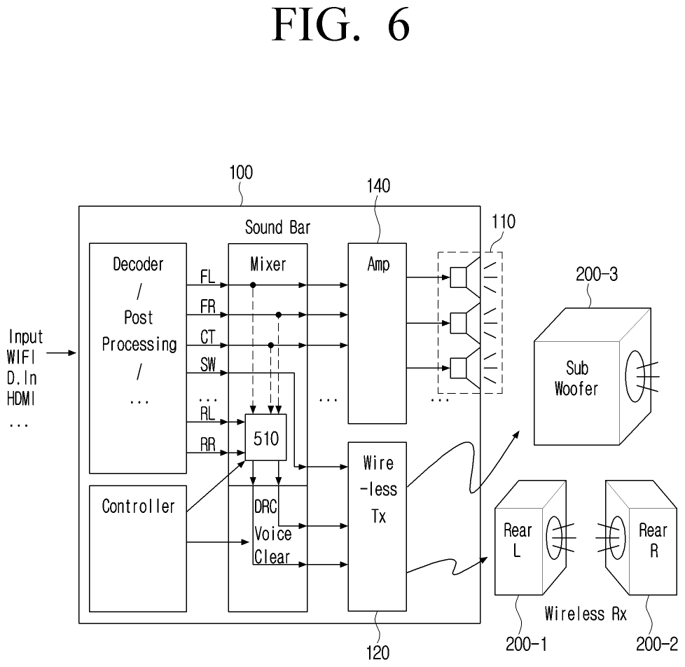

FIG. 6 is a view illustrating operation of a first mode of an electronic device 100 according to an embodiment. In FIG. 6, part designated in a dotted line represents that there is no flow of a signal.

The controller, if the electronic device 100 is in a first mode, may control the block 510 of the mixer not to mix signals of each channel. For example, the block 510 may include a first mixing unit which mixes a front left signal, a rear left signal, and a center signal, and a second mixing unit which mixes a front right signal, a rear right signal, and a center signal. Also, the block 510 of the mixer may include a switch at each of input ends of the front left signal, the front right signal, and the center signal. The controller may open the switch at each of the input ends of the front left signal, the front right signal, and the center signal and control not to substantially perform mixing in the first mixing unit and the second mixing unit.

Meanwhile, the disclosure is not limited thereto and the mixing method may be various in any degree. For example, the block 510 may include a third mixing unit which mixes the front left signal, the rear right signal, and the center signal. Also, each mixing unit may be implemented not to mix the center signal.

The controller, if the electronic device 100 is in the first mode, may turn off the sound processing module. The sound processing module is for facilitating identification of a user voice and minimizing damages of surrounding people due to the sound output when the electronic device 100 is in the second mode, wherein it may be turned off in the first mode which is a family listening mode to reduce electric power consumption.

FIG. 7 is a view illustrating operation of a second mode of an electronic device 100 according to an embodiment. In FIG. 7, part designated in dotted lines represents that there is no flow of a signal.

The controller, if the electronic device 100 is in the second mode, may not output sound through the speaker 110. Accordingly, the controller, if the electronic device 100 is in the second mode, may turn off the amp 140.

The controller, if the electronic device 100 is in the second mode, may control the block 510 of the mixer to mix signals of each channel. For example, the block 510 may include a first mixing unit which mixes a front left signal, a rear left signal, and a center signal, and a second mixing unit which mixes a front right signal, a rear right signal, and a center signal. Also, the block 510 of the mixer may include a switch at each of input ends of the front left signal, the front right signal, and the center signal. The controller may short-circuit the switch at each of the input ends of the front left signal, the front right signal, and the center signal and control the first mixing unit and the second mixing unit to perform mixing operations.

Meanwhile, the disclosure is not limited thereto and each mixing unit may be implemented to perform mixing after applying a gain to signals of each channel.

The controller, if the electronic device 100 is in the second mode, may apply at least one of a DRC or a filter which enhances clarity of a voice to the mixed signal.

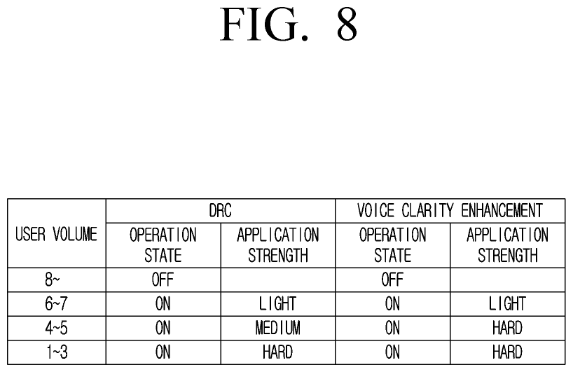

FIG. 8 is a view illustrating a sound processing module according to an embodiment.

As shown in FIG. 8, the controller, if the electronic device 100 is in the second mode, may apply at least one of a DRC or a filter which enhances clarity of a voice to the user voice in the mixed signal and may apply a DRC to background sound in the mixed signal. For example, the controller may apply a first DRC to increase an amplitude of a user voice and apply a second DRC to decrease an amplitude of background sound.

Also, the controller may change application strength of the DRC or the filter based on a user command. Otherwise, the controller may change the application strength of the DRC or the filer based on a volume of the electronic device 100.

Through this operation, the user may more clearly listen to a voice even if the volume of the electronic device 100 is low.

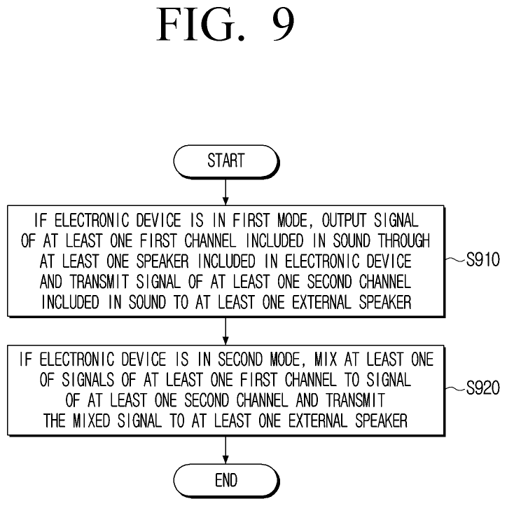

FIG. 9 is a flow chart illustrating a method of controlling an electronic device according to an embodiment.

In advance, the method includes, if the electronic device is in a first mode, outputting a signal of at least one first channel included in sound through at least one speaker included in the electronic device and transmitting a signal of at least one second channel included in the sound to at least one external speaker (S910). Further, the method includes, if the electronic device is in a second mode, mixing at least one of signals of the at least one first channel to a signal of the at least one second channel and transmitting the mixed signal to least one external speaker (S920).

Also, the method may further include applying at least one of a DRC or a filter to the mixed signal.

Further, the applying the at least one may include applying a first DRC to increase an amplitude of a user voice in the mixed signal and applying a second DRC to decrease an amplitude of background sound in the mixed signal, and applying a filter which enhances clarity of a voice to the user voice.

Also, the applying the at least one may include applying a DRC or a filter through a sound processing module, wherein the transmitting the signal of the at least one second channel to the at least one external speaker (S910) includes amplifying the signal of the at least one first channel by using an amp to provide the amplified signal to the at least one speaker and turning off the sound processing module, and the transmitting the mixed signal to the at least one external speaker may include turning off the amp.

Further, the method may further include changing a mode of the electronic device to one of the first mode or the second mode based on a volume of the electronic device.

Also, the transmitting the mixed signal to the at least one external speaker (S920) may include applying a first gain to at least one of the signals of the at least one first channel, applying a second gain to the signal of the at least one second channel, and mixing the at least one signal to which the first gain is applied and the signal of the at least one second channel to which the second gain is applied.

Further, the signal of the at least one first channel may include a front left signal, a front right signal, a center signal, and a sub-woofer signal, wherein the signal of the at least one second channel may include a rear left signal and a rear right signal, and the transmitting the signal of the at least one second channel to the at least one external speaker (S910) may include, if the electronic device is in the first mode, outputting the front left signal, the front right signal, and the center signal through the at least one speaker and transmitting the rear left signal, the rear right signal, and the sub-woofer signal to the at least one external speaker, and the transmitting the mixed signal to the at least one external speaker (S920) may include, if the electronic device is in the second mode, mixing the front left signal, the center signal, and the rear left signal, mixing the front right signal, the center signal, and the rear right signal, and transmitting the mixed signals to the at least one external speaker.

Also, the at least one external speaker may include a rear left speaker, a rear right speaker, and a woofer speaker, wherein the transmitting the signal of at least one second channel to the at least one external speaker (S910) may include, if the electronic device is in the first mode, transmitting the rear left signal to the rear left speaker, transmitting the rear right signal to the rear right speaker, and transmitting the sub-woofer signal to the woofer speaker, and the transmitting the mixed signal to the at least one external speaker (S920) may include, if the electronic device is in the second mode, mixing and transmitting the front left signal, the center signal, and the rear left signal to the rear left speaker, and mixing and transmitting the front right signal, the center signal, and the rear right signal to the rear right speaker.

Further, the method may further include, if the rear left speaker and the rear right speaker are not identified, mixing the front left signal and the rear left signal, mixing the front right signal and the rear right signal and outputting the mixed signals through at least one speaker.

Also, the method may further include identifying at least one of a number of a user or a position of the user around the electronic device, and changing the mode of the electronic device to one of the first mode or the second mode based on the identified information.

As above, according to various examples of the disclosure, the electronic device may provide a plurality of modes and minimize damages of surrounding people due to the sound output even in the case of the mode for individual use.

In particular, in the case of the mode for individual use, the electronic device may apply a DRC or a filter which enhances clarity of a voice to the mixed sound to improve user convenience.

Meanwhile, 5.1 channel sound is described in most of the description as above, but a method similar to the method described above may be applied to sound of various channels in any degree.

Also, the description is made such that the external speaker is described as two left and right speakers and one woofer speaker as above, but a configuration of the speaker may be also various in any degree.

Meanwhile, according to an embodiment of the disclosure, various examples described above may be implemented as software including instructions stored in a machine (e.g. computer) readable storage medium. The machine refers to a device which calls instructions stored in the storage medium and is operable according to the called instructions, wherein the machine may include an electronic device (e.g. an electronic device A) according to the disclosed embodiments. If the instructions are executed by a processor, the processor may perform a function corresponding to the instructions directly or by using other components under control of the processor. The instructions may include a code generated or executed by a compiler or an interpreter. A machine readable storage medium may be provided in a form of a non-transitory storage medium. Here, the term ‘non-transitory’ merely means that the storage medium does not include a signal and is tangible, wherein the term does not distinguish a case that data is stored in the storage medium semipermanently from a case that data is stored in the storage medium temporarily.

Also, according to an embodiment of the disclosure, the method according to various examples described above may be provided to be included in a computer program product. The computer program product may be traded between a seller and a buyer as goods. The computer program product may be distributed in a form of a machine readable storage medium (e.g. compact disc read only memory (CD-ROM)) or on-line via an application store (e.g. play store™). In the case of on-line distribution, at least part of the computer program product may be stored at least temporarily or may be generated temporarily in a storage medium such as memory of a server of a manufacturer, a server of an application store, or a relay server.

Also, according to an embodiment of the disclosure, various embodiments described as above may be implemented in a recording medium that may be read by a computer or a device similar thereto by using software, hardware, or a combination thereof. In some cases, the embodiments described in the specification may be implemented as a processor itself. According to software implementation, the embodiments such as procedures and functions described in the specification may be also implemented as separate software. Each software may perform one or more functions and operations described in the specification.

Meanwhile, computer instructions for performing the processing operation of the machine according to the various embodiments above may be stored in a non-transitory computer readable medium. Computer instructions stored in this non-transitory computer readable medium that, when executed by a processor of a specific device, causes the specific device to perform a processing operation of the device according to the various embodiments. The non-transitory computer readable medium does not mean a medium that stores data for a short time such as a resistor, a cache, memory, or the like but a machine readable medium that stores data semipermanently. A specific example of the non-transitory computer readable medium may be a CD, a DVD, a hard disk, a Blu-ray disk, a USB, a memory card, ROM, etc.

Also, each of components (e.g. a module or a program) according to the various embodiments above may be configured as a single item or a plurality of items, wherein a partial subcomponent of the aforementioned relevant subcomponents may be omitted, or another subcomponent may be further included in various embodiments. Mostly or additionally, some components (e.g. a module or a program) may be integrated into one item and may identically or similarly perform a function implemented by each of the relevant components before the integration. According to various embodiments, operations performed by a module, a program, or another component may be executed sequentially, in parallel, repetitively, or heuristically, or at least part of the operations may be executed in different orders or be omitted, or another operation may be added.

As the above, preferable examples of the present disclosure are shown and described. However, it is obvious that the disclosure is not limited to the aforementioned specific examples, and various modifications may be implemented by those skilled in the art without deviating from the gist of the disclosure claimed in the scope of claims, wherein these modifications should not be independently understood from the technical spirit or prospect of the disclosure.

What is claimed is:

1. An electronic device comprising:
at least one speaker;
a communication interface; and
at least one processor configured to:
based on the electronic device being in a first mode, output a signal of at least one first channel included in sound through the at least one speaker and control the communication interface to transmit a signal of at least one second channel included in the sound to at least one external speaker, and
based on the electronic device being in a second mode, mix at least one of signals of the at least one first channel and a signal of the at least one second channel to thereby produce a mixed signal, and control the communication interface to transmit the mixed signal to the at least one external speaker.

2. The electronic device of claim 1, wherein the at least one processor is configured to:
apply at least one of a dynamic range control (DRC) or a filter to the mixed signal.

3. The electronic device of claim 2, wherein the at least one processor is configured to:
apply a first DRC to increase an amplitude of a user voice in the mixed signal and apply a second DRC to decrease an amplitude of background sound in the mixed signal, and
apply the filter which enhances clarity of a voice to the user voice.

4. The electronic device of claim 2, further including:
an amplifier (amp) which amplifies and provides the signal of the at least one first channel to the at least one speaker,
wherein the at least one processor includes:
a mixer configured to perform the mixing, and
a sound processing module configured to apply the DRC or the filter,
wherein the at least one processor is configured to:
based on the electronic device being in the first mode, turn off the sound processing module, and
based on the electronic device being in the second mode, turn off the amp.

5. The electronic device of claim 1, wherein the at least one processor is configured to:
change a mode of the electronic device to one of the first mode or the second mode based on a volume of the electronic device.

6. The electronic device of claim 1, wherein the at least one processor is configured to:
apply a first gain to at least one of the signals of the at least one first channel,
apply a second gain to the signal of the at least one second channel, and
mix the at least one of the signals of the at least one first channel to which the first gain is applied and the signal of the at least one second channel to which the second gain is applied.

7. The electronic device of claim 1, wherein
the signal of the at least one first channel includes a front left signal, a front right signal, a center signal, and a sub-woofer signal,
the signal of the at least one second channel includes a rear left signal and a rear right signal, and
the at least one processor is configured to:
based on the electronic device being in the first mode, output the front left signal, the front right signal, and the center signal through the at least one speaker and control the communication interface to transmit the rear left signal, the rear right signal, and the sub-woofer signal to the at least one external speaker, and
based on the electronic device being in the second mode, mix the front left signal, the center signal, and the rear left signal, mix the front right signal, the center signal, and the rear right signal, and control the communication interface to transmit the mixed signals to the at least one external speaker.

8. The electronic device of claim 7, wherein
the at least one external speaker includes:
a rear left speaker, a rear right speaker, and a woofer speaker, and the at least one processor is configured to:
based on the electronic device being in the first mode, control the communication interface to transmit the rear left signal to the rear left speaker, transmit the rear right signal to the rear right speaker, and transmit the sub-woofer signal to the woofer speaker, and
based on the electronic device being in the second mode, mix and control the communication interface to transmit the front left signal, the center signal, and the rear left signal to the rear left speaker, mix and control the communication interface to transmit the front right signal, the center signal, and the rear right signal to the rear right speaker.

9. The electronic device of claim 8, wherein the at least one processor is configured to:
based on the rear left speaker and the rear right speaker being not identified, mix the front left signal and the rear left signal, mix the front right signal and the rear right signal and output the mixed signals through the at least one speaker.

10. The electronic device of claim 1, further comprising:
a sensor,
wherein the at least one processor is configured to:
identify at least one of a number of a user or a position of the user around the electronic device through the sensor, and
change a mode of the electronic device to one of the first mode or the second mode based on the identified at least one of a number of a user or a position of the user.

11. A method of controlling an electronic device, comprising:
based on the electronic device being in a first mode, outputting a signal of at least one first channel included in sound through at least one speaker included in the electronic device and transmitting a signal of at least one second channel included in the sound to at least one external speaker; and
based on the electronic device being in a second mode, mixing at least one of signals of the at least one first channel and a signal of the at least one second channel to thereby produce a mixed signal, and transmitting the mixed signal to the at least one external speaker.

12. The method of claim 11, further comprising:
applying at least one of a DRC or a filter to the mixed signal.

13. The method of claim 12, wherein the applying includes:
applying a first DRC to increase an amplitude of a user voice in the mixed signal and applying a second DRC to decrease an amplitude of background sound in the mixed signal; and
applying the filter which enhances clarity of a voice to the user voice.

14. The method of claim 12, wherein
the applying includes:
applying the DRC or the filter through a sound processing module,
the transmitting the signal of the at least one second channel to the at least one external speaker includes:
amplifying the signal of the at least one first channel by using an amp to provide an amplified signal to the at least one speaker and turning off the sound processing module, and
the transmitting the mixed signal to the at least one external speaker includes:
turning off the amp.

15. The method of claim 11, further comprising:
changing a mode of the electronic device to one of the first mode or the second mode based on a volume of the electronic device.
